(19) United States
(12) Patent Application Publication
(10) Pub. No.: US 2009/0041431 A1
(43) Pub. Date: Feb. 12, 2009

(54) Imaging Apparatus and Method for Controlling the Same

(76) Inventors: Toshihiko Ono, Yokohama (JP); Satoshi Yagi, Ooi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/164,238

(22) Filed: Jun. 30, 2008

(30) Foreign Application Priority Data
Aug. 9, 2007 (JP) 2007-207795

(51) Int. Cl. H04N 5/00

(52) U.S. Cl. 386/117

(57) ABSTRACT

In an imaging apparatus that records shot video on a first recording medium, extracts a frame image of a desired frame of the shot video recorded on the first recording medium, and records the frame image on a second recording medium and a method for controlling the imaging apparatus, a frame image of a specified frame in the shot video is reproduced and displayed from the first recording medium and, a crop outline of a size selected through an external operation is displayed on the frame image, and the image portion enclosed in the crop outline of the frame image is recorded on the second recording medium.

### CROSS-REFERENCES TO RELATED APPLICATIONS

This application relates to and claims priority from Japanese Patent Application No. JP 2007-207795, filed on Aug. 9, 2007, the entire disclosure of which is incorporated herein by reference.

### BACKGROUND

1. Field of the Invention

The present invention relates to an imaging apparatus and a method for controlling the imaging apparatus and is suitable for application to a video camcorder, for example.

2. Description of Related Art

Consumer video camcorders have been developed and made commercially available recently that include the function of extracting an image of a desired frame of shot video recorded on an inserted optical disk or built-in hard disk and recording it in a memory card such as an SD (Secure Digital) card (hereinafter the function will be referred to as the still-image capture function) (See Japanese Patent Application Laid-Open No. 2007-180739).

On the other hand, high-definition technology has been also introduced in the field of consumer video camcorders and many video camcorders are on the market that are capable of storing video with a 16:9 aspect ratio in addition to the conventional 4:3 aspect-ratio video on optical disks and built-in hard disks.

### SUMMARY

Many of newer printers on the market are capable of reading image data directly from memory cards and printing images based on the image data. Many users of video camcorders that include still-image capture function use such printers to print an image extracted from shot video recorded on a memory card (hereinafter the image will be referred to as a captured image) at home.

When a conventional video camcorder record a captured image on a memory card with the still-image capture function, the camcorder records the image of a frame specified by a user from a shot video sequence on the memory card without modification. Accordingly, the aspect ratio of the captured image is the same as that of the original shot video.

Therefore, to print a captured image extracted from shot video with an aspect ratio of 16:9, for example, as a photograph with an aspect ratio of 4:3, which is a common photograph format, a personal computer on which software for converting the aspect ratio of the captured image extracted from shot video to 4:3 is installed is required.

It would be convenient if a captured image extracted from shot video could be printed as a photograph with a different aspect ratio on such a printer without using a device such as a personal computer.

The present invention has been made in light of these circumstances and an object of the present invention is to provide an imaging apparatus and a method for controlling the imaging apparatus capable of improving functionality.

In order to solve the problem, the present invention provides an imaging apparatus that records shot video on a first recording medium, extracts an image of a desired frame of the shot video recorded on the first recording medium, and records the extracted image on a second recording medium, including: a reproducing section reproducing the shot video recorded on the first recording medium; a display section displaying the shot video reproduced from the first recording medium by the reproducing section; a crop outline displaying section displaying on the display section a frame image of a specified frame in the shot video reproduced by the reproducing section and displaying a crop outline of a size specified through an external operation on the frame image; and a recording section recording an image portion enclosed in the crop outline of the frame image on the second recording medium.

The present invention also provides a method for controlling an imaging apparatus that records shot video on a first recording medium, extracts an image of a desired frame of the shot video recorded on the first recording medium, and records the extracted image on a second recording medium, including: a first step of reproducing and displaying a frame image of a specified frame in the shot video from the first recording medium and displaying on the frame image a crop outline of a size selected through an external operation; and a second step of recording an image portion enclosed in the crop outline of the frame image on the second recording medium.

According to the present invention, a frame image of a desired frame of shot video can be printed as a photograph with an aspect ratio different from that of the shot video without using a device such as a personal computer and therefore the functionality of the imaging apparatus can be improved.

Other aspects and advantages of the invention will be apparent from the following description and the appended claims.

### BRIEF DESCRIPTION OF THE DRAWINGS

FIG. 1 is a block diagram showing an entire configuration of a video camcorder according to an embodiment of the present invention;

FIG. 2 is a flowchart illustrating a procedure of a first still-image capture process;

FIG. 3 shows schematic diagrams ((A) to (E)) used for explaining the first still-image capture process;

FIG. 4 is a flowchart illustrating a procedure of a second still-image capture process;

FIG. 5 shows schematic diagrams ((A) to (E)) used for explaining the second still-image capture process;

FIG. 6 shows schematic diagrams ((A-1) to (A-5) and (B-1) to (8-5)) used for explaining a third still-image capture process; and

FIG. 7 is a flowchart illustrating a procedure of the third still-image capture process.

### DETAILED DESCRIPTION OF PREFERRED EMBODIMENTS

Embodiments of the present invention will be described with reference to the accompanying drawings.

### (1) First Embodiment

(1-1) Configuration of a Video Camcorder According to a First Embodiment

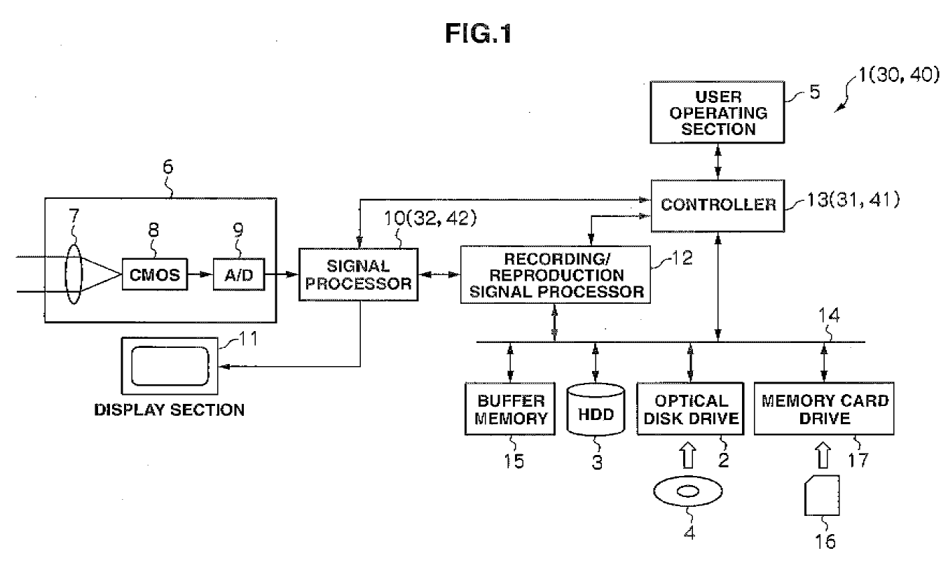

Reference numeral in FIG. 1 denotes a video camcorder according to an embodiment of the present invention in its entirety. The video camcorder 1 includes an built-in optical disk drive 2 and a built-in hard disk drive 3 and is capable of recording and storing shot video on an optical disk 4 such as a DVD (Digital Versatile Disc) or a BD (Blu-ray disk) as well as on a hard disk.

In practice, when a user operating section 5 of the video camcorder 1 is operated to select a shooting mode, an image of a subject is formed on a COMS (Complementary Metal Oxide Semiconductor) 8 by an imaging optical system 7 of an imaging section 6 and the image is converted to electrical image signal by photoelectrical conversion at the CMOS 8. The image signal thus obtained is provided to a signal processor 10 as imaging data through an analog/digital converter 9. An audio signal of external sound output from a built-in microphone, not shown, included in the video camcorder 1 is also provided to the signal processor 10.

The signal processor 10 applies predetermined signal processing such as gamma correction and AGC (Auto Gain Control) to the imaging data provided, applies analog/digital conversion to the audio signal provided, and sends video data of the resulting video and audio data to a display section 11 formed by an LCD (Liquid Crystal Display) or the like. As a result, video (that is, the current shot video) based on the video data is displayed on the display section 11. At the same time, the signal processor 10 also sends the video data and audio data to a recording/reproduction signal processor 12.

The recording/reproduction signal processor 12 applies predetermined recording signal processing such as modulation, compression, and error-correcting code adding to the video data and audio data provided from the signal processor 10 under the control of a controller 13 and stores the resulting recording video data and recording audio data in a buffer memory 15 through a data bus 14.

The recording video and audio data stored in the buffer memory 15 are subsequently read by the optical disk drive 2 or the hard disk drive 3 through the data bus 14 and stored in a optical disk 4 or a hard disk under the control of the controller 13.

On the other hand, when the user operating section 5 is operated to select a reproduction mode, the controller 13 controls corresponding one of the optical disk drive 2 and the hard disk drive 3 to reproduce the recording video data and recording audio data recorded on the optical disk 4 or the hard disk. The reproduced recording video and audio data are stored on the buffer memory 15.

The recording video data and the recording audio data stored in the buffer memory 15 are subsequently read out by the recording/reproduction signal processor 12 through the data bus 14 under the control of the controller 13. The recording/reproduction signal processor 12 applies predetermined reproduction signal processing such as error correction, decompression, and demodulation to the read recording video data and recording audio data and sends the resulting video data and audio data to the signal processor 10.

The signal processor 10 applies predetermined signal processing such as AGC to the provided video data and audio data, then sends the resulting video data to the display section 11 and the resulting audio data to a built-in speaker, not shown, included in the video camcorder 1 under the control of the controller 13. As a result, video based on the reproduced video data is displayed on the display section 11 and sound based on the reproduced audio data is output from the speaker.

(1-2) Still-Image Capture Function According to the Embodiment

A still-image capture function included in the video camcorder 1 as described above will be described next. The video camcorder 1 includes a first still-image capture function that extracts a portion of a desired frame of shot video based on recording video data recorded on the optical disk 4 or the hard disk as a still image with a 4:3 or 16:9 aspect ratio and records the still image on a memory card 16.

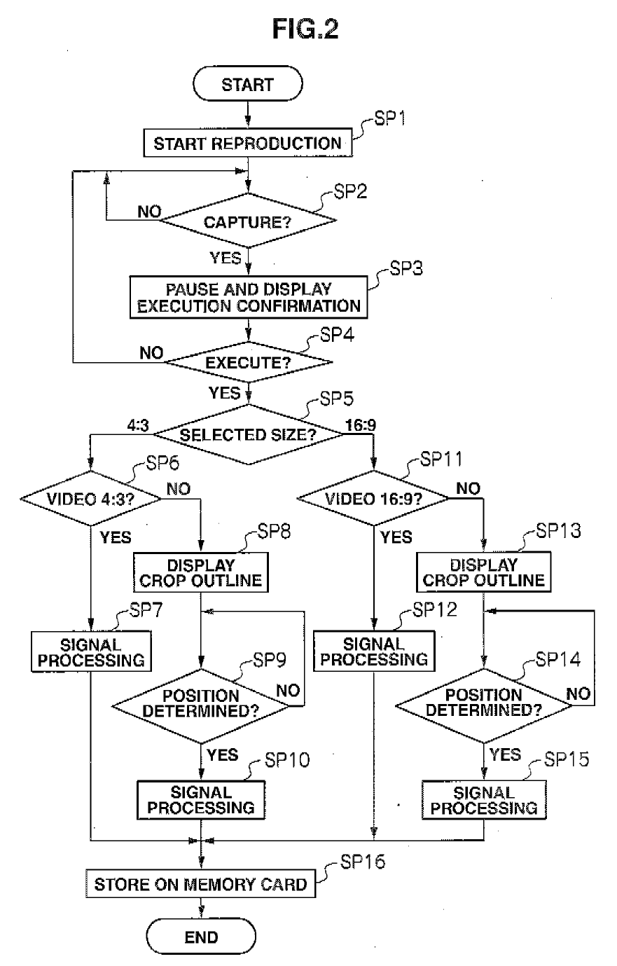

FIG. 2 is a flowchart illustrating a process performed by the controller 13 relating to the first still-image capture function. The controller 13 performs the first still-image capture process shown in FIG. 2 in accordance with a corresponding control program stored in an internal memory, not shown.

When the user operating section 5 is operated to input an instruction to execute the first still-image capture process, the controller 13 starts the first still-image capture process and controls corresponding one of the optical disk drive 2 and the hard disk drive 3 to start reproduction of shot video based on the recording video data recorded on the optical disk 4 or the hard disk. The controller 13 also controls the recording/reproduction signal processor 12 and the signal processor 10 to display shot video reproduced from the optical disk 4 or the hard disk on the display section 11 (SP1).

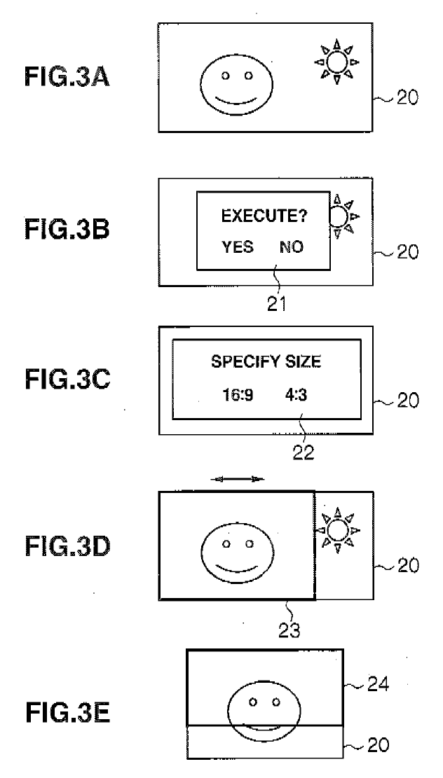

Then the controller 13 waits until the user operating section 5 is operated to specify a frame to be captured (SP2). When such a frame is specified, the controller 13 controls the corresponding optical disk drive 2 or hard disk drive 3 to pause the reproduction of the shot video. As a result, a frame image 20 of the specified frame in the shot video is displayed on the display section 11 as shown in FIG. 3(A), for example. At the same time, the controller 13 controls the signal processor 10 to display an execution confirmation dialog 21 as shown in FIG. 3(B) on the display section 11 to ask a user whether to execute the still-image capture process (SP3).

The controller 13 then waits until one of an option (“No”) not to execute the first still-image capture process and an option (“Yes”) to execute the first still-image capture process displayed in the execution confirmation dialog 21 (SP4) is selected. When the user operating section 5 is operated to select the former option, the controller 13 returns to step SP1. On the other hand, when the latter option is selected, the controller 13 controls the signal processor 10 to display a size confirmation dialog 22 as shown in FIG. 3(C) on the display section 11 to ask the user which of aspect ratios “4:3” and “16:9” to use as the aspect ratio of the captured image to be recorded on the memory card 16 (SP5).

Then the controller 13 waits until one of the aspect ratios “4:3” and “16:9” is selected as the aspect ratio of the captured image to be recorded on the memory card 16. When the user operating section 5 is operated to select the former option, the controller 13 determines whether the aspect ratio of the original shot video is the same as the selected aspect ratio, “4:3” (SP6).

If the determination is affirmative, the controller 13 sends a corresponding command to the recording/reproduction signal processor 12 and a memory card drive 17. In response to the command, the recording/reproduction signal processor 12 reads recording video data of the frame image 20 currently displayed on the display section 11 from the buffer memory 15. The recording/reproduction signal processor 12 applies the reproduction signal processing mentioned above to the recording video data, then compression-encodes the video data resulting from the reproduction signal processing into a predetermined still-image compression format such as the JPEG (Joint Photographic Experts Group), and stores the resulting still-image data in the buffer memory 15 (SP7).

The memory card drive 17, in response to the command, reads out the still image data stored in the buffer memory 15 through the data bus 14 and records it in the memory card 16 inserted in the video camcorder 1 (SP16).

On the other hand, if the determination at step SP6 is negative, the controller 13 sends a corresponding command to the signal processor 10. In response to the command, the signal processor 10 causes a crop outline 23 whose vertical dimension is the same as that of the frame image 20 and whose aspect ratio is 4:3 to be displayed on the frame image 20 currently displayed on the display section 11 as shown in FIG. 3(D) (SP8).

When subsequently a right button, not shown, on the user operating section 5 is operated, the controller 13 controls the signal processor 10, in response to the operation, to move the crop outline 23 rightward; when a left button, not shown, in the user operating section 5 is operated, the controller 13 controls the signal processor 10, in response to the operation, to move the crop outline 23 leftward. The controller 13 waits until the position of the crop outline 23 is determined while moving the crop outline 23 displayed on the display section 11 rightward and leftward in response to operation of the right and left buttons on the user operating section 5 in this way (SP9).

When an enter button, not shown, on the user operating section 5 is eventually operated, the controller 13 sends a corresponding command to the recording/reproduction signal processor 12 and the memory card drive 17. In response to the command, the recording/reproduction signal processor 12 reads recording video data corresponding to the image portion enclosed in the crop outline 23 in the frame image 20 currently displayed on the display section 11 from the buffer memory 15, converts the recording video data to still-image data in a format compliant to a predetermined still-image compression standard as in step SP7, and then stores the still-image data in the buffer memory 15 (SP10). The memory card drive 17, based on the command, reads the still-image data stored in the buffer memory 15 through the data bus 14 and records it on the memory card 16 (SP16).

On the other hand, if “16:9” is selected at step SP5 as the aspect ratio of the captured image to be recorded on the memory card 16, the controller 13 determines whether the aspect ratio of the original shot video is the same as the selected aspect ratio, “16:9”.

If the determination is affirmative, the controller 13 sends a corresponding command to the recording/reproduction signal processor 12 and the memory card drive 17. In response to the command, the recording/reproduction signal processor 12 converts the recording video data corresponding to the frame image currently displayed on the display section 11 to still-image data as in step SP7, and stores the still-image data in the buffer memory 15 (SP12). Based on the command, the memory card drive 17 reads the still-image data stored in the buffer memory 15 through the data bus 14 and records it on the memory card 16 (SP 16).

On the other hand, if the determination at step SP11 is negative, the controller 13 sends a corresponding command to the signal processor 10. In response to the command, the signal processor 10 causes a crop outline 24 having the same horizontal dimension as that of the frame image 20 currently displayed on the display section 11 and an aspect ratio of 16:9 on the frame image 20 (SP13).

When subsequently a down button, not shown, on the user operating section 5 is operated, the controller 13 controls the signal processor 10, in response to the operation, to move the crop outline 24 downward; when an up button, not shown, on the user operating section 5 is operated, the controller 13 controls the signal processor 10, in response to the operation, to move the crop outline 24 upward. The controller 13 waits until the position of the crop outline 24 is determined while moving the crop outline 24 displayed on the display section 11 upward and downward in response to operation of the up and down buttons on the user operating section 5 in this way (SP14).

When the enter button on the user operating section 5 is eventually operated, the controller 13 sends a corresponding command to the recording/reproduction signal processor 12 and the memory card drive 17. In response to the command, the recording/reproduction signal processor 12 reads recording video data corresponding to the image portion enclosed in the crop outline 24 in the frame image 20 currently displayed on the display section 11 from the buffer memory 15, converts the recording video data to still-image data as in step SP7, and then stores the still-image data in the buffer memory 15 (SP15). The memory card drive 17, based on the command, reads the still-image data stored in the buffer memory 15 through the data bus 14 and records it on the memory card 16 (SP16).

(1-3) Advantages of the Embodiment

In the video camcorder 1 according to the embodiment described above, a portion of a desired frame of shot video based on recording video data recorded oh an optical disk 4 or a hard disk can be extracted as a captured image of a specified size (with an aspect ratio of 4:3 or 16:9) and can be recorded on a memory card 16. Therefore, a captured image with a desired aspect ratio can be recorded on a memory card 16 regardless of the aspect ratio of shot video. Accordingly, a photograph with a desired aspect ratio can be obtained without using a personal computer and hence the functionality of the video camcorder can be improved.

### (2) Second Embodiment

Reference numeral 30 in FIG. 1 represents a video camcorder according to a second embodiment in its entirety. The video camcorder 30 has the same configuration as that of the video camcorder 1 according to the first embodiment except that a second still-image capture function is included that allows the position and size of a portion of an image to be extracted from a desired frame of shot video displayed on a display section 11 to be flexibly set.

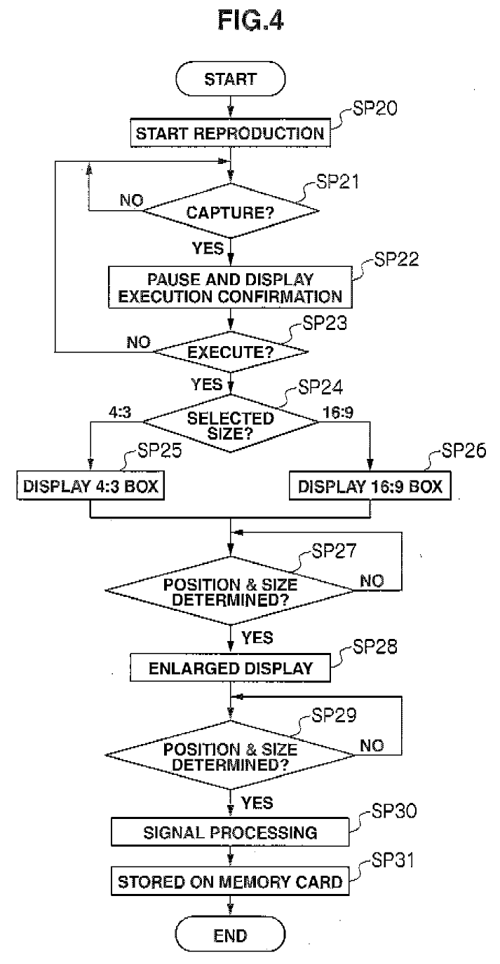

FIG. 4 is a flowchart illustrating a specific process performed by a controller 31 relating to the second still-image capture function. The controller 31 performs the second still-image capture process shown in FIG. 4 in accordance with a corresponding control program stared in an internal memory, not shown.

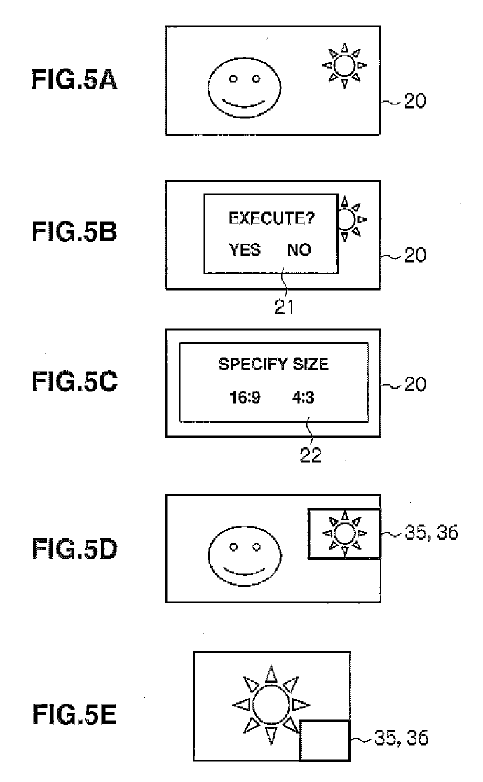

When a user operating section 5 is operated to input an instruction to execute the second still-image capture process, the controller 31 starts the second still-image capture process and performs steps SP20 to SP24 in the same way as in steps SP1 to SP5 of the first still-image capture process described with reference to FIG. 2 (see FIG. 5((A) to (C))).

When “4:3” is selected at step SP24 as the aspect ratio of a captured image to be recorded on a memory card 16 in a size confirmation dialog 22 (FIG. 5(C)) displayed on a display section 11, the controller 31 controls a signal processor 32, in response to the selection, to display a crop outline 35 with an aspect ratio of 4:3 on a frame image 20 displayed on the display section 11 as shown in FIG. 5(D) (SP25). The crop outline 35 may be displayed in any position and size.

On the other hand, when “16:9” is selected at step S24 as the aspect ratio of the captured image to be recorded on the memory card 16, the controller 31 controls the signal processor 32, in response to the selection, to display a crop outline 36 with an aspect ratio of 16:9 on the frame image 20 displayed on the display section 11 as shown in FIG. 5(D) (SP26). The crop outline 36 may be displayed in any position and size.

When subsequently an up, down, right, or left button on the user operating section 5 is operated, the controller 31 controls the signal processor 32 to move the crop outline 35, 36 up, down, right or left in accordance with the operation. When a zoom button, not shown, on the user operating section 5 is operated, the controller 31 controls the signal processor 32 to enlarge or reduce the crop outline 35, 36 in accordance with the operation without changing the aspect ratio. The controller 31 waits until the position and size of the crop outline 35, 36 is determined while moving the crop outline 35, 36 displayed on the display section 11 up, down, right or left or enlarging or reducing the crop outline 35, 36 in accordance with the user's operation (SP27).

When an enter button on the user operating section 5 is eventually operated, the controller 31 sends a corresponding command to a recording/reproduction signal processor 12 and a memory card drive 17. In response to the command, the recording/reproduction signal processor 12 reads recording video data corresponding to a portion of the frame image 20 currently displayed on the display section 11 that is enclosed in the crop outline 35,36 from the buffer memory 15. The recording/reproduction signal processor 12 applies reproduction signal processing mentioned above to the recording video data and sends the resulting video data to the display section 11 through the signal processor 32. As a result, the image portion of the frame image 20 displayed on the display section 11 that is enclosed in the crop outline 35, 36 whose positions and size are determined at step SP27 is extracted from the frame image 20 and displayed on the display section 11 in an enlarged form (SP28).

The signal processor 32 also displays the same crop outline 35, 36 as those displayed at step SP25 or SP26 on the enlarged image displayed on the display section 11 (FIG. 5(E)). The controller 31 then waits until the position and size of the crop outline 35, 36 are determined, as in step SP27 (SP29). While the crop outline 35, 36 is displayed in FIG. 5(E) to allow the user to change the position and size of the crop outline 35, 36 also in FIG. 5(E), the crop outline 35, 36 does not need to be displayed if the position and size of the crop outline 35, 36 is not allowed to be changed in FIG. 5(E) for simplifying the process.

When the enter button on the user operating section 6 is eventually operated, the controller 31 sends a corresponding command to the recording/reproduction signal processor 12 and the memory card drive 17. In response to the command, the recording/reproduction signal processor 12 reads recording video data corresponding to the image portion currently enclosed in the crop outline 35, 36 of the extracted image currently displayed on the display section 11 from the buffer memory 15, converts the recording video data to still-image data in a predetermined still-image compression coding format as in step SP7 of the first still-image capture process described with reference to FIG. 2, and then stores the still-image data in the buffer memory 15 (SP30). The memory card drive 17, based on the command, reads the still-image data stored in the buffer memory 15 through the data bus 14 and records it on the memory card 16 (SP31).

In the video camcorder 30 according to the embodiment, the size of an image portion extracted from a frame image specified by a user in shot video can be flexibly set. Therefore, only a desired image portion of a desired scene can be extracted and recorded on a memory card 16.

Since the trend in video camcorders are moving toward higher pixel densities, a captured image with a large number of pixels can be obtained even if only a desired image portion of a desired scene is extracted as described above. Accordingly, a high-resolution photograph can be obtained when the captured image is printed.

### (3) Third Embodiment

Reference numeral 40 in FIG. 1 represents a video camcorder according to a third embodiment in its entirety. The video camcorder 40 has the same configuration as that of the video camcorder 1 according to the first embodiment except that a third still-image capture function is included that provides continuous captured images.

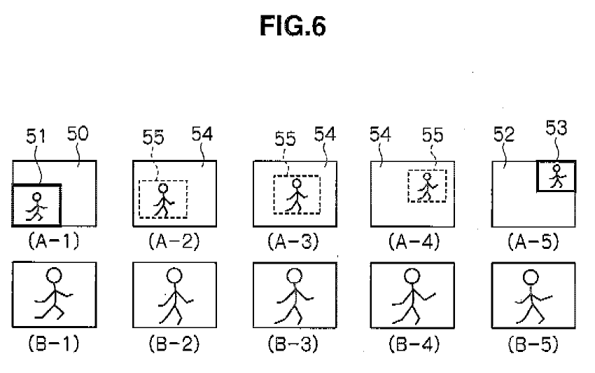

The video camcorder 40 according to the embodiment sets a first crop outline 51 on a frame image 50 of an arbitrary first frame of shot video as shown in FIG. 6(A-1) and also sets a second crop outline 53 on a frame image 52 of a second frame after the first frame as shown in FIG. 6(A-5), thereby automatically setting a virtual, third frame whose position and size gradually changes from the position and size of the first crop outline 51 to the position and size of the second crop outline 53 on frame images 54 of third frames located at predetermined intervals between the first and second frames 50 and 52 as shown in FIG. 6(A-1) to (A-5). Then, the video camcorder 40 extracts the image portion enclosed in the first to third crop outlines 51, 53, and 55 in the frame images 50, 54, and 52 of the first to third frames as shown in FIG. 6(B-1) to (B-5) and records them as a series of captured images on a memory card 16.

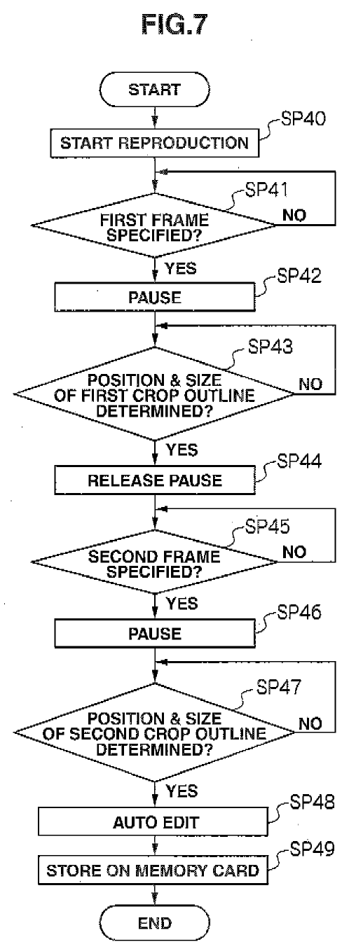

FIG. 7 is a flowchart illustrating a specific process performed by the controller 41 relating to the third still-image capture function. The controller 41 performs the third still-image capture process shown in FIG. 7 in accordance with a corresponding control program stored in an internal memory, not shown.

When a user operating section 6 is operated to input an instruction to execute the third still-image capture process, the controller 41 starts the third still-image capture process. The controller 41 controls corresponding one of an optical disk drive 2 and a hard disk drive 3 to start reproduction of shot video based on recording video data recorded on an optical disk 4 or a hard disk. The controller 41 also controls a recording/reproduction signal processor 12 and a signal processor 42 to display shot video reproduced from the optical disk 4 or the hard disk on a display section 11 (SP40).

Then, the controller 41 waits until a first frame in which a first crop outline 51 is to be set is specified (SP41). When the user operating section 5 is operated to specify the first frame, the controller 41 controls the optical disk drive 2 and the hard disk drive 3 and the recording/reproduction signal processor 12 to pause the reproduction (SP42). Accordingly, here the frame image 50 of the first frame specified by the user is displayed on the display section 11.

Then, the controller 41 controls the signal processor 42 to display a size confirmation dialog 22 as described with respect to FIG. 3(C) on the display section 11, thereby allowing the user to specify the size (an aspect ratio of 4:3 or 16:9) of the first crop outline 51 (and a second crop outline 53). When a size of the first crop outline 51 (and the second crop outline 53) is selected in the size confirmation dialog 22, the controller 41 controls the signal processor 42 to display the first crop outline 51 with the size on the frame image 50 of the first frame.

When subsequently an up, down, right, or left button on the user operating section 5 is operated, the controller 41 controls the signal processor 42, in response to the operation, to move the first crop outline 51 displayed on the frame image 50 of the first frame up, down, right, or left. When a zoom button, not shown, on the user operating section 5 is operated, the controller 41 controls the signal processor 42, in response to the operation, to enlarge or reduce the first crop outline 51. The controller 41 waits until the position and size of the first crop outline 51 is determined while moving the first crop outline 51 up, down, right, and left and enlarging and reducing the crop outline 51 in accordance with the user's operation (SP43).

When an enter button on the user operating section 5 is eventually operated, the controller 41 sends a corresponding command to the optical disk drive 2 and the hard disk drive 3 and the recording/reproduction signal processor 12 to release the pause of the reproduction and resume the reproduction of the shot video (SP44).

Then the controller 41 waits until a second frame on which the second crop outline 53 is to be set is specified (SP45). When the user operating section 5 is operated to specify the second frame, the controller 41 controls the optical disk dive 2 and the hard disk drive 3 and the recording/reproduction signal processor 12 to pause the reproduction (SP46). Consequently, here, the frame image 52 of the second frame specified by the user is displayed on the display section 11.

Then, the controller 41 controls the signal processor 42 to display the second crop outline 53 with the size selected by the user at step SP43 on the frame image 52 of the second frame.

When subsequently the up, down, right, or left button on the user operating section 5 is operated, the controller 41 controls the signal processor 42 to move the second crop outline 53 displayed on the frame image 52 of the second frame up, down, right, or left in accordance with the operation; when the zoom button on the user operating section 5 is operated, the controller 41 controls the signal processor 42 to enlarge or reduce the second crop outline 53 in accordance with the operation. The controller 41 wais until the position and size of the second crop outline 53 is determined while moving the second crop outline 53 up, down, right, and left or enlarging and reducing the second crop outline 53 in accordance with the users operation (SP47).

When the enter button on the user operating section 5 is eventually operated, the controller 41 selects a third frame from among frames between the first and second frames at predetermined intervals and sets a virtual third crop outline 55 on the frame image 54 of each of the selected third frames in such a manner that the position and size of the third crop outline 55 are gradually changed from the position and size of the first crop outline 51 to the position and size of the second crop outline 53. In particular, the position and size of the virtual third crop outline 55 are set in such a manner that the positions and sizes of the first and second crop outlines are linearly interpolated. Alternatively, a subject of shooting may be recognized and the position and size of the virtual third crop outline 55 may be set so that the center of the crop outline 55 is positioned at the subject. This is because the image portion of the subject can be more appropriately extracted. Then the controller 41 extracts in sequence the image portions enclosed in the first to third crop outlines 51, 55, and 53 thus set on the first to third frames (SP48).

Specifically, the controller 41 controls the optical disk drive 2 or the hard disk drive 3 to read recording video data of the first to third frames from the optical disk 4 or the hard disk and stores it in a buffer memory 15.

The controller 41 also sends a predetermined command to the recording/reproduction signal processor 12 and the memory card drive 17. In response to the command, the recording/reproduction signal processor 12 sequentially reads the recording video data corresponding to the portions enclosed in the first to third crop outlines 51, 55, and 53 set on the frame images 50, 54, and 52 of the first to third frames from the buffer memory 15, converts the recording video data to still-image data in a predetermined still-image compression coding format as in step SP6 of the first still-image capture process described with respect to FIG. 2, then stores the still-image data in the buffer memory 15. The memory card drive 17, based on the command, reads the still-image data stored in the buffer memory 17 through a data bus 14 and records the still-image data on the memory card 16 (SP49).

As has been described, in the video camcorder according to the present embodiment, first and second crop outlines 51 and 53 are set to automatically set a third virtual crop outline 55 on each of third frame images located at regular intervals between first and second frames in such a manner that the position and size of the third crop outline 55 gradually change from the position and size of the first crop outline 51 to the position and size of the second crop outline 53, and the image portions enclosed in the first to third crop outlines 51, 53, and 55 in the frame images 50, 54, and 52 of the first to third frames are extracted and recorded on a memory card 16 as captured images. Therefore, for example, a portion of an image of a moving person or vehicle can be continuously extracted from shot video and can be recorded on a memory card 16 as captured images. This facilitates the acquisition of captured images and therefore the significantly improves the functionality of the video camcorder.

### (4) Other Embodiments

While the first to third embodiments have been described in which the present invention is applied to video camcorders 1, 30, 40 in which the first recording medium on which shot video is recorded is an optical disk 4 or a hard disk and the second recording medium on which captured images are recorded is a memory card 16, the present invention is not limited to these. The present invention is widely applicable to video camcorders in which the first recording medium is a magnetic tape and/or the second recording medium is the same as the first recording medium. In this case, the reproducing section that reproduces shot video recorded on the first recording medium and the recording section that records captured images on the second recording medium may be drives suitable for the first and second recording media.

While the first to third embodiments have been described in which signal processor 10, 32, 42 that applies predetermined signal processing such as gamma correction and AGC to imaging data in the shooting mode is used as the crop outline displaying section for displaying a crop outline 23, 24, 35, 51, 53 with a size selected through an external operation on a frame image of a frame specified by a user, the present invention is not so limited. The crop outline displaying section may be provided separately from the signal processor 10, 32, 42.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. An imaging apparatus that records shot video on a first recording medium, extracts an image of a desired frame of the shot video recorded on the first recording medium, and records the extracted image on a second recording medium, comprising:
a reproducing section reproducing the shot video recorded on the first recording medium;
a display section displaying the shot video reproduced from the first recording medium by the reproducing section;
a crop outline displaying section displaying on the display section a frame image of a specified frame in the shot video reproduced by the reproducing section and displaying a crop outline of a size specified through an external operation on the frame image; and
a recording section recording an image portion enclosed in the crop outline of the frame image on the second recording medium.

2. The imaging apparatus according to claim 1, wherein the crop outline displaying section moves the crop outline displayed on the frame image in a specified direction in response to an external operation.

3. The imaging apparatus according to claim 1, wherein the crop outline displaying section enlarges or reduces the crop outline displayed on the frame image in response to an external operation.

4. The imaging apparatus according to claim 1, wherein the crop outline displaying section sets first and second crop outlines on frame images of first and second frames of the shot image in response to an external operation and sets a virtual, third crop outline on frame images of third frames located at regular intervals between the first and second frames in such a manner that the position and size of the third crop outline gradually change from the position and size of the first crop outline to the position and size of the second crop outline; and
the recording section records on the second recording medium the image portion enclosed in the first, second or third crop outline in each of the frame images of the first, second and, third frames.

5. A method for controlling an imaging apparatus that records shot video on a first recording medium, extracts an image of a desired frame of the shot video recorded on the first recording medium, and records the extracted image on a second recording medium, comprising:
a first step of reproducing and displaying a frame image of a specified frame in the shot video from the first recording medium and displaying on the frame image a crop outline of a size selected through an external operation; and
a second step of recording an image portion enclosed in the crop outline of the frame image on the second recording medium.

6. The method for controlling an imaging apparatus according to claim 5, wherein, in the first step, the crop outline displayed on the frame image is moved in a specified direction in response to an external operation.

7. The method for controlling an imaging apparatus according to claim 5, wherein, in the first step, the crop outline displayed on the frame image is enlarged or reduced in response to an external operation.

8. The method for controlling an imaging apparatus according to claim 5, wherein:
in the first step, first and second crop outlines are set on frame images of first and second frames of the shot image in response to an external operation and a virtual, third crop outline is set on frame images of third frames located at regular intervals between the first and second frames in such a manner that the position and size of the third crop outline gradually change from the position and size of the first crop outline to the position and size of the second crop outline; and
in the second step, the image portion enclosed in the first, second or third crop outline in each of the frame images of the first, second and, third frames is recorded on the second recording medium.
